(19) United States
(12) Patent Application Publication
(10) Pub. No.: US 2020/0094980 A1
(43) Pub. Date: Mar. 26, 2020

(54) STRUCTURE, SUSPENSION SYSTEM, ENGINE ASSEMBLY AND AIRCRAFT

(71) Applicant: AIRBUS (BEIJING) ENGINEERING CENTRE COMPANY LIMITED, Beijing (CN)

(72) Inventors: Li GUO, Beijing (CN); Yukun HUANG, Beijing (CN)

(21) Appl. No.: 16/574,317

(22) Filed: Sep. 18, 2019

(30) Foreign Application Priority Data
Sep. 20, 2018 (CN) 201811120343.6

(51) Int. Cl. B64D 29/06; B64D 29/02; B64D 27/18; B64D 33/04

(52) U.S. Cl. CPC B64D 29/06; B64D 33/04; B64D 27/18; B64D 29/02

(57) ABSTRACT

A structure for an aircraft is disclosed including a fixed part, a panel member which is an outer member of the structure, and a plurality of connection units. Each of the plurality of connection units connects the panel member to the fixed part in an articulated manner. The plurality of connection units collectively forms an iso-static connection between the panel member and the fixed part, so that the structure has an invariant geometry. A suspension system, an engine assembly, and an aircraft including the structure are also disclosed.

This application claims priority to Chinese Patent Application No. 201811120343.6, titled “Structure, suspension system, engine assembly and aircraft”, filed with the China National Intellectual Property Administration on Sep. 20, 2018, which is incorporated by reference in its entirety herein.

### FIELD OF THE DISCLOSURE

The present disclosure relates to the field of aircrafts, and in particular to an aft pylon fairing with statically determinate connection, a suspension system, an engine assembly, and an aircraft.

More specifically, the present disclosure relates to the connection of a panel member in an aircraft, wherein the panel member may be an outermost member of a structure (in particular, an outermost member of the aircraft), or has large deformation compared with surrounding structures in use, or has such requirements as light weight, low cost, easy disassembly and maintenance, etc.

### BACKGROUND OF THE DISCLOSURE

In aircraft engineering, an outer panel member is generally fixed by rigid connection. The connection implemented by means of fasteners such as screws and rivets, as a typical form of the rigid connection, is widely used in fixation of structures in an aircraft. However, in an application scenario where the aircraft needs to meet strict requirements in terms of weight, accuracy, cost, and maintenance, and the like, the rigid connection by means of fasteners may not be optimal.

In the following, the above case is explained by taking an aft pylon fairing in a suspension system of the aircraft as an example.

The suspension system is designed to form a connection interface between an engine and a wing of the aircraft. The aft pylon fairing (APF), as one of secondary structures in the suspension system, has a variety of functions, including forming a thermal or fire resistant barrier and forming aerodynamic continuity between the engine exhaust and the suspension pylon. Therefore, the APF is required to have a light weight, high temperature resistance, and excellent aerodynamic performance. In addition, as one of the secondary structures (non-primary structures) in the suspension system of the aircraft, the aft pylon fairing is hoped to have low costs in materials, manufacturing, maintenance, and the like.

However, an aft pylon fairing in the conventional technology still needs to be improved to meet these requirements well.

The aft pylon fairing includes a heat protection deck located at a lower portion thereof, which is more prone to expand thermally due to direct contact with a high temperature jet emitted by the engine compared with other components of the aft pylon fairing. In the conventional technology, the components of the aft pylon fairing, including the heat protection deck, are generally fixed together by the rigid connection, which results in that the heat protection deck cannot expand freely when subject to the high temperature, thus generating a high thermal stress and thus causing too concentrated local stress.

In addition, in the conventional technology, due to the rigid connection, vibration of the lower panel is generated when the lower panel is subject to the high temperature flow emitted from the engine, which is directly transferred to adjacent structures.

Particularly, in most cases, the heat protection deck is rigidly connected to a body portion of the fairing via fasteners such as rivets, so that a large number of fasteners are required, which results in the increased weight and increased cost, and adds complexity to assembly and/or disassembly of the fairing.

It is also known to those skilled in the art that when the lower panel or any other structure in the aft pylon fairing needs to be repaired or replaced, the operation is complex therefore leading to higher costs.

Therefore, further improvement in the connection of the aft pylon fairing in the conventional technology is desirable, in particular in relation to the fixation of the heat protection deck at the lower portion.

### SUMMARY OF THE DISCLOSURE

A general summary is provided in this section, rather than a comprehensive presentation of full scope of the present disclosure or all of the features of the present disclosure.

The present disclosure is intended to at least partly overcome and/or mitigate the above problems in the conventional technology.

An object of the present disclosure is to provide a non-rigid connection structure that can be used for the connection of an outer panel member in an aircraft.

Another object of the present disclosure is to provide a connection structure including a reduced number of connectors.

Another object of the present disclosure is to provide a connection structure that is easily disassembled and installed.

Another object of the present disclosure is to provide a connection structure by which a manufacturing cost can be saved.

Another object of the present disclosure is to provide a connection structure by which the weight of an aircraft can be reduced.

Still another object of the present disclosure is to provide a structure (an aft pylon fairing) that allows a lower panel thereof to freely thermally expand.

Still another object of the present disclosure is to provide a structure (an aft pylon the service life can be prolonged.

Yet another object of the present disclosure is to provide a suspension system having an improved aft pylon fairing.

Yet another object of the present disclosure is to provide an engine assembly having an improved suspension system.

Yet another object of the present disclosure is to provide an aircraft having an improved engine assembly.

In order to achieve at least one of the above objects, a structure for an aircraft is provided in the present disclosure. The structure includes: a fixed part; a panel member which is an outer member of the structure; and a plurality of connection units. Each of the plurality of connection units connects the panel member to the fixed part in an articulated manner. The plurality of connection units collectively form a reliable connection between the panel member and the fixed part so as to make the structure be an iso-statically connected body.

Each of the plurality of connection units includes: a first element which is fixed to or integrally formed on the fixed part; a second element which is fixed to or integrally formed on the panel member at a position corresponding to the first element; and a third element which couples the first element and the second element together. The third element is configured to allow the first element and the second element to pivot with respect to each other or allow the first element and the second element to pivot and translate with respect to each other.

Optionally, the plurality of connection units include at least a first connection unit and a second connection unit. The first connection unit and the second connection units are arranged to allow the panel member to pivot with respect to the fixing part around a first axis and a second axis in different directions, respectively, so that the first connection unit and the second connection unit collectively form reliable connection between the panel member and the fixing part. Preferably, both the first axis and the second axis extend along a plane in which the panel member is located. The first element and the second element of the first connection unit are connected via the third element of the first connection unit to be translatable by a distance with respect to each other along the first axis, and/or the first element and the second element of the second connection unit are connected via the third element of the second connection unit to be translatable by a distance with respect to each other along the second axis.

Alternatively, the plurality of connection units include at least a first connection unit, a second connection unit, and a third connection unit. The first connection unit, the second connection unit and the third connection unit collectively form statically determinate connection between the panel member and the fixing part. The first connection unit, the second connection unit, and the third connection unit are arranged to allow the panel member to pivot with respect to the fixing part around three axes in space, respectively, and the first connection unit, the second connection unit, and the third connection unit are arranged in a non-collinear manner.

Optionally, the first element and the second element of one of the first connection unit, the second connection unit, and the third connection unit are connected via the corresponding third element to be translatable with respect to each other, the first element and the second element of one of the remaining two of the connection units are connected via the corresponding third element to be translatable with respect to each other along a first axis on a plane in which the panel member is located, and the first element and the second element of the other of the remaining two of the connection units are connected via the corresponding third element to be translatable with respect to each other along both the first axis and a second axis different from the first axis on the plane in which the panel member is located. Or optionally, the first element and the second element of one of the first connection unit, the second connection unit and the third connection unit are connected via the corresponding third element to be translatable with respect to each other along a first axis on a plane in which the panel member is located, and the first element and the second element of each of the remaining two of the connection units are connected via the corresponding third element to be translatable with respect to each other along a second axis different from the first axis on the plane in which the panel member is located.

Preferably, the plurality of connection units further include at least one standby connection unit. The standby connection unit is configured to provide complementary constraints in a case that one or more of the first connection unit, the second connection unit and the third connection unit fail; and/or one or more of the first connection unit, the second connection unit and the third connection unit are provided with a fail-safe mechanism.

The third element includes at least a structure such as a pin, a bolt, a stud, a rolling bearing and a joint bearing that allows the first element and the second element to pivot with respect to each other. Optionally, the third element further includes a structure such as a sliding bushing that allows the first element and the second element to translate with respect to each other.

Preferably, there is no rigid connection between the panel member and other parts of the structure than the panel member; or there is no rigid connection between the panel member and other parts of the structure than the panel member and there is no direct contact between the panel member and other parts of the structure than the panel member under the circumstance that the panel member is not expanded and deformed.

With the structure for an aircraft according to the present disclosure, rigid connection of the panel member is avoided, so that the panel member can freely expand and deform. Further, the panel member can be fixed by only a minimum of two connection units, which greatly reduces the number of fasteners or eliminates use of fasteners such as rivets and bolts, significantly simplifies the assembly and disassembly of the structure, and reduces the thickness of the panel member due to the reduced number of fasteners, thereby reducing the overall weight, and reducing the maintenance cost and the manufacturing cost. In addition, the connection units in the present disclosure do not need to bear a great stress generated by inconsistency of thermal deformation between the connected components.

Optionally, the plurality of connection units have the same or similar configuration, so that the elements are suitable for mass production, which saves the cost.

Specifically, the structure for an aircraft according to the present disclosure is an aft pylon fairing, and the panel member is an outer panel of the aft pylon fairing for maintaining aerodynamic performance and/or for heat protection.

In the case of the aft pylon fairing according to the present disclosure, by using the connection units provided in the present disclosure, the lower panel is allowed to freely expand, and the heat and the thermal deformation cannot be transferred to the adjacent components including lateral panels, the ribs, the side beams or even the upper panel (a base plate), so that the thermal stress of the adjacent components may be greatly reduced, and these structures may have reduced thickness and size or a simple shape, which allows a low manufacturing accuracy, thereby reducing the overall weight and greatly saving the manufacturing and assembly costs. Further, a large number of fasteners are omitted, so that fatigue crack formation around the fasteners may be avoided, and the service life of the elements may be prolonged.

In order to achieve at least one of the above objects, according to another aspect of the present disclosure, there is further provided a suspension system for an engine. The suspension system is arranged between an aircraft wing and the engine and is located below or above the aircraft wing, and the suspension system includes the aft pylon fairing as described in the previous aspect.

In order to achieve at least one of the above objects, according to still another aspect of the present disclosure, there is further provided an engine assembly including an engine and the suspension system for an engine as described in the previous aspect.

In order to achieve at least one of the above objects, according to yet another aspect of the present disclosure, there is further provided an aircraft including at least one engine assembly as described in the previous aspect.

Other advantages and features of the present disclosure will become clear in the following non-limitative detailed description.

### BRIEF DESCRIPTION OF THE DRAWINGS

Features and advantages of one or more embodiments of the present disclosure are understood more easily with reference to the following description in conjunction with the drawings in which:

FIG. 1 shows a schematic perspective view of an aft pylon fairing in the related technology;

FIG. 2 shows a schematic perspective view of an aircraft including an engine assembly provided in the present disclosure;

FIG. 3 shows a schematic side view of an engine assembly of an aircraft, the engine assembly including an aft pylon fairing according to an embodiment of the present disclosure;

FIG. 4 shows a schematic perspective view of an aft pylon fairing according to a first embodiment of the present disclosure, in which one lateral panel is omitted for clarity of connection units;

FIG. 5 shows a schematic perspective view of an aft pylon fairing according to a second embodiment of the present disclosure, in which one lateral panel is omitted for clarity of connection units;

FIG. 6 is a sectional view of a first connection unit according to the second embodiment of the present disclosure taken along the y-axis;

FIG. 7 is a sectional view of a second connection unit according to the second embodiment of the present disclosure taken along the x-axis; and

FIG. 8 is a sectional view of a third connection unit according to the second embodiment of the present disclosure taken along the x-axis.

Throughout the drawings, corresponding reference numerals indicate corresponding parts.

### DETAILED DESCRIPTION

The present disclosure is described in detail hereinafter with reference to the drawings by means of exemplary embodiments. The following detailed description of the present disclosure is only for the purpose of illustration rather than limitation to the present disclosure and applications or usages thereof.

Terms such as “first”, “second”, and “third”, are used herein to describe various elements, components, regions, layers, and/or sections, but these elements, components, regions, layers, and/or sections should not be limited by these terms. These terms may be only used to distinguish one element, component, region, layer or section from another element, component, region, layer or section. For example, the terms such as “first”, “second”, and other numerical terms do not imply a sequence or order unless clearly indicated by the context. Therefore, a first element, component, region, layer or section described below may also be referred to as a second element, component, region, layer or section without departing from teachings of exemplary configurations.

In the description of the present disclosure, it should be understood that, terms such as “upper”, “lower”, “front”, “rear” and other terms for indicating directions or position relationships are described based on directions or position relationships shown in the drawings, which are merely for convenience of describing the present disclosure and simplification of the description, and do not indicate or imply that a described device or element must have a particular direction, be constructed and operated in a particular direction, and thus should not be construed to limit the present disclosure. For example, in a case where an engine is arranged above an aircraft wing, the statement “the panel member is an outer member of the structure and is arranged under the fixed part” may also be understood as “the panel member is an outer member of the structure is arranged above the fixed part”.

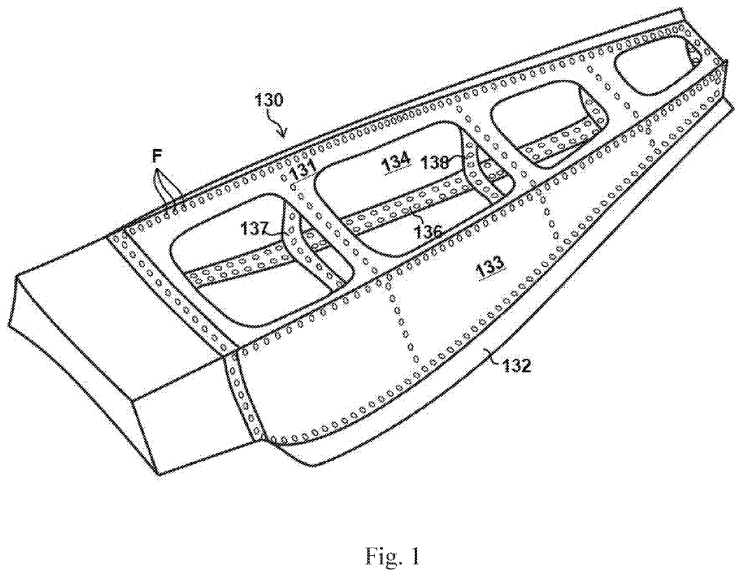

FIG. 1 shows a perspective view of an aft pylon fairing 130 in the related technology. As shown in FIG. 1, the aft pylon fairing 130 is substantially in the form of a box. The box includes an upper panel 131 located at an upper portion of the box, a heat protection deck (which is also used for maintaining aerodynamic performance and is hereinafter referred to as a “lower panel”) 132 located at a lower portion of the box, and two lateral panels 133, 134 assembled by inner transverse stiffener ribs 137, 138 and side beams 136. The inner stiffener ribs 137, 138 are spaced at intervals from each other in a longitudinal direction of the fairing 130.

The lower panel 132 is rigidly connected to the side beams 136 and/or the ribs 137, 138 with a large number of fasteners F, so as to be firmly fixed in the aft pylon fairing 130. This requires that lower edges of the side beams 136 and the ribs 137, 138 have a curvature that perfectly conforms to a curve of the lower panel 132. In addition, due to the direct rigid connection between the ribs 137, 138 and the lower panel 132, it is required that the lower edges of the ribs 137, 138 extend downwards to engage with the lower panel.

During operation of the engine, the lower panel 132 is in direct contact with high temperature air flow in an inner bypass of the engine, which results in large thermal expansion in the lower panel 132. By contrast, the other adjacent components such as the two lateral panels 133 and 134, the side beams 136, and the ribs 137, 138, are not in direct contact with the high temperature air flow and thus generally involve small thermal expansion. Since the lower panel 132 is directly and rigidly connected to the adjacent components involving small thermal expansion via a large number of fasteners F, the thermal expansion of the lower panel 132 is inevitably constrained by the components, and thus generating a high thermal stress.

With regard to the lateral panels 133, 134, thanks to the positions thereof, the lateral panels 133, 134 involve no significant deformation caused by high temperature air flow. However, in the fixed connection state, the lateral panels 133, 134 inevitably endure local high temperatures due to heat conduction from the lower panel 132, thereby making higher demands on the heat resistance of the material. Meanwhile, since the overall thermal expansion of the lateral panels 133, 134 is much smaller than that of the lower panel 132, a great thermal stress still exists due to the mutual constraint between the lateral panels 133, 134 and the lower panel 132.

Further, it should also be noted that the ribs 137, 138 are arranged inside the box, which is hardly affected by the hot and cold air flows. However, due to the rigid connection between the ribs 137, 138 and the lower panel 132, the same problem as that of the lateral panels 133, 134 occurs in the ribs 137, 138.

As is well known to those skilled in the art, the lower panel 132 is subjected to a jet impingement during the service of the aircraft. The rigid structure used in the related technology may be subject to higher fatigue cycles due to the vibration loads and/or temperature expansion loads.

In addition, in the related technology, the lower panel 132 is generally manufactured by superplastic forming technology from a large metal alloy blank. In order to ensure the overall aerodynamic performance, the lower panel 132 is generally required to have a large and precisely-sized thickness to ensure that the ends of the fasteners such as rivets are flush with a surface of the lower panel. However, this requirement not only requires that the lower panel 132 has a sufficient thickness, but also requires that the thickness meets strict tolerances. Therefore, there are high requirements on manufacturing processes for such panels are costly.

In the assembly process of the aft pylon fairing 130 in the related technology, almost every component needs to be connected using a large number of fasteners F, and thus the assembled aft pylon fairing 130 includes a large amount of fasteners F, which not only results in a high cost, but also increases the overall weight of the fairing, and requires more time and manpower during the assembly. In addition, since mounting holes of the connected components need to accurately match with each other all the time, a high manufacturing accuracy and a small tolerance range are required, which also results in a high part scrap rate during manufacturing.

As well known, at different positions, the lower panel of the aft pylon fairing has different temperature distributions, different thermal stresses and thermal deformations caused by thermal expansion. The inventors of the present disclosure have found after many texts that the stress is most concentrated near the longitudinal ends of the lower panel. The rigid connector, for example fasteners, has to withstand a significant shear stress at a position where the stress of the lower panel is concentrated, leading to greater thickness being required, which results in higher weight.

When the lower panel needs to be repaired or replaced, in the related technology, it is generally required to remove the entire fairing, and then disassemble the panel member by disassembling the fasteners. This process needs to be performed by a technical specialist of a specialized agency by means of special tools, which results in a high cost and takes the service time of the aircraft.

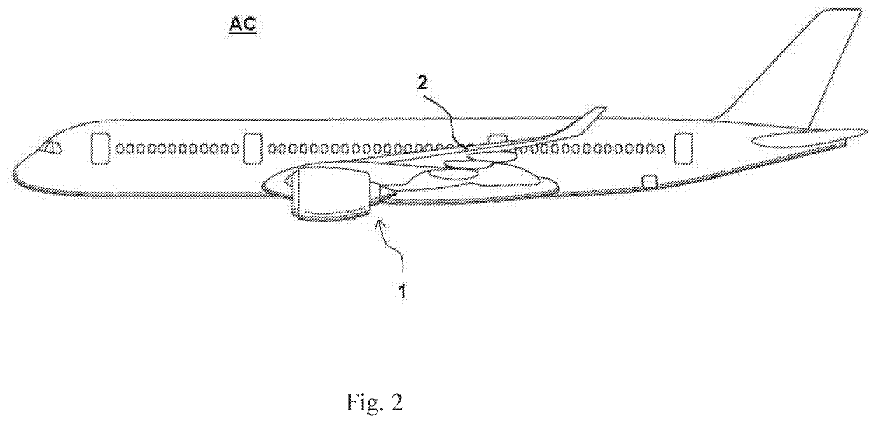

FIG. 2 shows a schematic diagram of an aircraft AC including an engine assembly 1 according to the present disclosure.

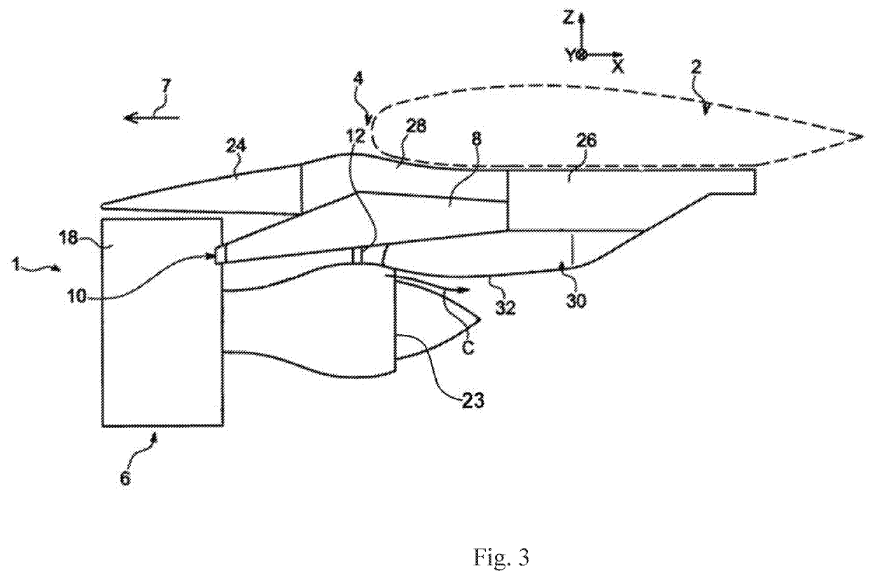

FIG. 3 shows the engine assembly 1 to be fixed under the aircraft wing 2. The assembly includes a suspension system 4 and an engine 6 such as a turbojet suspended under the suspension system 4.

To facilitate the description of position relationships between components, a three-dimensional coordinate system shown in the figure is provided. In the following, unless otherwise stated, the x direction is the longitudinal direction of the suspension system 4 and is in fact also the longitudinal direction of the engine 6 and the longitudinal direction of the aft pylon fairing that will be described below. The y direction is the transverse direction of the suspension system 4 and is also the transverse direction of the engine 6 and the transverse direction of the aft pylon fairing. The z direction is the vertical direction of the suspension system 4. The three directions x, y, and z are orthogonal to each other.

In addition, the terms “front” and “rear” are defined based on a direction of movement of the aircraft caused by the thrust applied by the engine 6, “front” corresponds to the front in the direction of movement of the aircraft, and “rear” corresponds to the rear in the direction of movement of the aircraft. The front direction is schematically illustrated by an arrow 7.

Overall, the suspension system 4 includes a rigid structure 8 as a primary structure that carries a suspension device for the engine 6. The suspension device includes at least a front engine suspension 10 and a rear engine suspension 12 provided between the rigid structure 8 and a large fan casing 18 and a central casing 22 of the engine, respectively. Both the front engine suspension 10 and the rear engine suspension 12 may be conventionally designed in a manner known to those skilled in the art.

The suspension system 4 further includes a plurality of secondary structures, i.e., a front pylon structure 24, a rear pylon structure 26, a connection fairing 28 for the front pylon structure and the rear pylon structure, and an aft pylon fairing 30.

Overall, in addition to the aft pylon fairing 30 that will be described in detail below, other secondary structures may be designed in a known manner.

The aft pylon fairing 30 is located under the rigid structure 8 and the rear pylon structure 26. The aft pylon fairing 30 forms a heat barrier and forms aerodynamic continuity between the engine exhaust and the suspension system, so as to protect the suspension system and the wing from the effect of heat dissipated by the core engine flow C.

In a manner known to those skilled in the art, the aft pylon fairing 30 includes a lower panel 32, which is also referred to as a heat protection deck, for protecting the suspension system and the wing from the effect of the core engine flow C. The lower panel 32 has an outer surface that directly contacts the core engine flow C. It should be noted that in the case where the engine 6 is suspended under the aircraft wing as described in this embodiment, the lower panel 32 forms a lower portion of the aft pylon fairing 30. Naturally, in the alternative case where the engine is designed to be mounted above the wing, the lower panel 32 forms an upper portion of the aft pylon fairing.

As can be seen in FIG. 3, the front end of the lower panel 32 is very close to the rear end of the engine nozzle 23.

FIG. 3 shows a part of the aft pylon fairing 30 according to the embodiment of the present disclosure. The aft pylon fairing 30 is generally in a box configuration that will be mounted on the rear pylon structure 26 and the rigid structure 8.

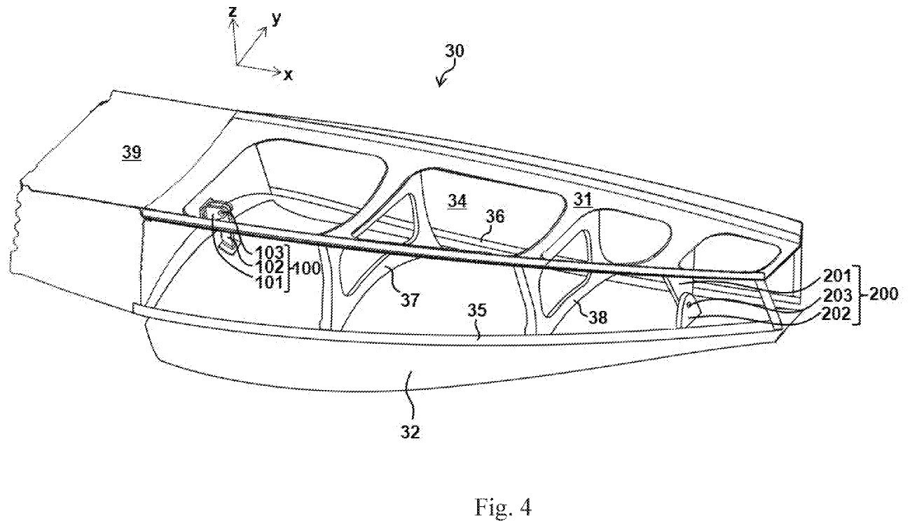

Referring to FIG. 4, the aft pylon fairing 30 includes an upper panel 31 (corresponding to the base plate provided in the present disclosure) located at an upper portion of the aft pylon fairing 30, a lower panel 32 that extends substantially parallel to the upper panel 31, and two lateral panels. The two lateral panels are respectively located at both lateral sides of the aft pylon fairing 30 and are generally oriented along the x-z plane. In FIG. 4, only one lateral panel 34 is shown for convenience of showing the inner structure of the fairing 30. The aft pylon fairing 30 further includes two longitudinal side beams 35 and 36 located at a lower portion of the aft pylon fairing 30, and the two side beams may be integrally formed as a wing panel when necessary. The aft pylon fairing 30 further includes a plurality of transverse stiffening ribs 37 and 38, which are spaced at intervals from each other along the x direction inside the fairing 30. Each of the plurality of ribs is substantially oriented along the y-z plane and is for example in the form of a rectangle, a square or a U shape. The aft pylon fairing 30 further includes a front casing 39 at the front end and a conical rear casing at the rear end (which is not shown). It is should be noted herein that the upper panel 31, the ribs 37 and 38, and the front casing 39 and the like form the fixed part according to the present disclosure.

It should further be noted that each component of the fixed part may be made of a single piece, or may also be composed of a plurality of parts rigidly fixed to each other.

In the aft pylon fairing 30, the front casing 39, the upper panel 31, the lateral panels 34, the side beams 35 and 36, the ribs 37 and 38, and the rear casing are rigidly fixed to each other and collectively form a primary structure. Connection units specific to the present disclosure that will be described below are used to connect the primary structure and the heat protection deck, i.e., the lower panel 32.

In the embodiment according to the present disclosure, the lower panel 32 is connected to the primary structure not by a large number of fasteners, but only by two or more reasonably arranged connection units. Each connection unit is a flexible connection device, preferably an articulation device; and more preferably a connection device including a ball joint assembly and an axial sliding bushing.

A first exemplary embodiment of the present disclosure is shown in FIG. 4, in which two connection units 100 and 200 are included, and the two connection units will be described below.

The first connection unit 100 is located at an approximately middle transverse position of the front end portion of the lower panel 32. The first connection unit 100 includes: a first element 101 fixed on a vertical surface of the front casing 39 along the x-axis, a second element 102 fixed on the lower panel 32 along the z-axis, and a third element 103 that couples the first element 101 and the second element 102 together along the y-axis. The first element 101 has a double lug structure with two through holes being respectively provided at corresponding positions of the two lugs. The second element 102 is an elongated panel with a through hole at the upper end. The upper end of the second element 102 is arranged between the two lugs of the first element 101, and the through hole of the second element 102 is aligned with the two through holes of the first element 101. The third element 103 passes through the above three through holes and couples the first element 101 and the second element 102 together. Preferably, the thickness of the second element 102 in the y-axis direction is equal to or slightly smaller than the spacing between the two lugs of the first element 101. The third element 103 may be any one of connecting elements such as a pin, a bolt or a stud, and at least forms a loose fit (i.e., a clearance fit) with the through hole of the second element 102, which may also be implemented by, for example, transition fitting.

The first connection unit 100 is configured to allow the first element 101 and the second element 102 to pivot with respect to each other only around the y-axis, but not allow the first element 101 and the second element 102 to translate and pivot with respect to each other in other directions. In other words, the first connection unit 100 enables the lower panel 32 to pivot with respect to the primary structure only around the y-axis, while constraining the movement of the lower panel 32 along the x-axis, the y-axis, and the z-axis and the pivot of the lower panel 32 around the x-axis and the z-axis.

The second connection unit 200 is located close to the rear end of the lower panel 32 and includes: a first element 201 fixed on the upper panel 31 along the z-axis, a second element 202 fixed on the lower panel 32 along the z-axis, and a third element 203 that couples the first element 201 and the second element 202 together along the x-axis. The first element 201 is a lug with a through hole at the lower end, the second element 202 is a lug with a through hole at the upper end, and the through hole of the first element 201 is aligned with the through hole of the second element 202. The third element 203 passes through the above two through holes and couples the first element 201 and the second element 202 together. The third element 203 may include any one of connecting elements such as a pin, a bolt or a stud, and at least forms a loose fit with the through hole of the first element.

The second connection unit 200 is configured to allow the first element 201 and the second element 202 to pivot with respect to each other around the x-axis, but not allow the first element 201 and the second element 202 to move and pivot with respect to each other in other directions. In other words, the second connection unit 200 enables the lower panel 32 to pivot with respect to the primary structure only around the x-axis, while constraining the movement of the lower panel 32 along the x-axis, the y-axis, and the z-axis and the pivot of the lower panel 32 around the y-axis and the z-axis.

With the above two connection units 100 and 200, six freedom degrees of the lower panel 32 can be fully constrained, and the reliable connection of the lower panel 32 with respect to the primary structure is formed, and thus the structure has an invariant geometry including a statically determinate structure and a statically indeterminate structure.

It is conceivable that both the first element and the second element of each connection unit in the present disclosure may be fixed to the corresponding components by any possible rigid connection manners such as welding and riveting, and may also be integrally formed on the corresponding components.

It is also conceivable that the first connection unit and the second connection unit may be formed in other forms, and the third element in each of the first connection unit and the second connection unit may further include components that are used for the relative pivot between the first elements and the corresponding second elements, such as ball bearings, and/or components that allow the relative translation between the first elements and the corresponding second elements, such as sliding bushings.

Therefore, it is apparent to those skilled in the art that various optimizations and modifications may be made to the first embodiment.

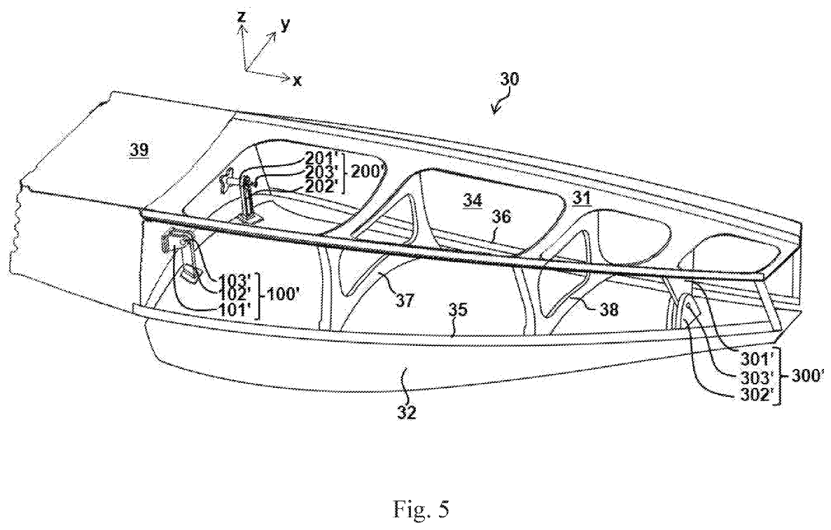

FIG. 5 shows a more preferred second exemplary embodiment of the present disclosure in which the lower panel 32 is connected via three connection units 100′, 200′ and 300′. The three connection units 100′, 200′ and 300′ are respectively described below.

The first connection unit 100′ is located at the left side of the front end portion of the lower panel 3. As an example, the first connection unit 100′ includes: a first element 101′ fixed on a vertical surface of the front casing 39 along the x-axis, a second element 102′ fixed on the lower panel 32 along the z-axis, and a third element 103′ that couples the first element 101′ and the second element 102′ together along the y-axis. The first element 101′ has a double lug structure with two through holes being respectively provided at corresponding positions of the two lugs. The second element 102′ is an elongated panel with a through hole 1021′ at the upper end. The upper end of the second element 102′ is arranged between the two lugs of the first element 101′, and a center line of the through hole 1021′ of the second element 102′ is aligned with center lines of the two through holes of the first element 101′. The third element 103′ passes through the above three through holes and couples the first element 101′ and the second element 102′ together.

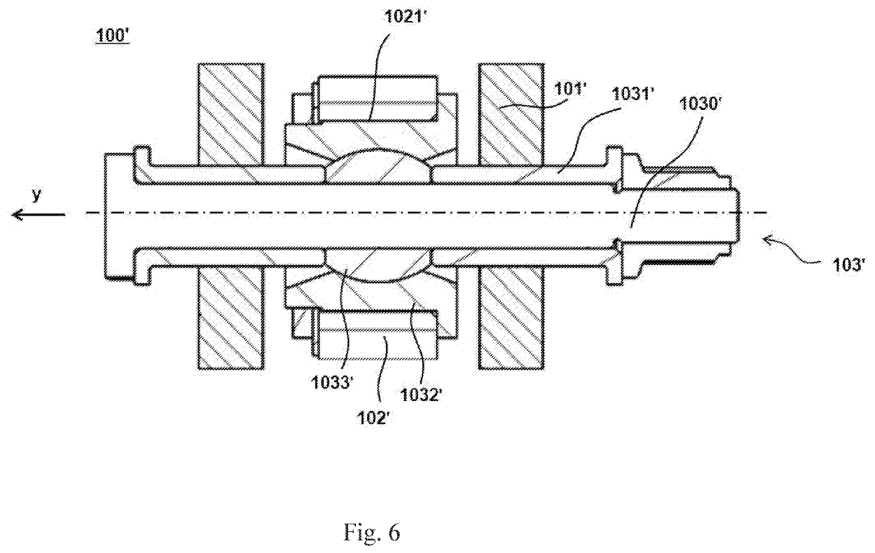

Different from the first embodiment, as specifically shown in FIG. 6, the third element 103′ includes a pin shaft 1030′, a sliding bushing 1031′ arranged on the pin shaft 1030′, a ball joint assembly and a stopper. The pin shaft 1030′ may be in the form of a pin, a bolt or a stud. The ball joint assembly includes a ball socket 1032′ and a ball head 1033′ that are arranged in the through hole 1021′ of the second element 102′ and are freely pivotable with respect to each other. The sliding bushing 1031′ passes through the two through holes of the first element 101′ and allows the first element 101′ to slide on an outer surface of the sliding bushing 1031′. The thickness of the second element 102′ in the y-axis direction is less than the spacing between the two lugs of the first element 101′.

The first connection unit 100′ is configured to allow the first element 101′ and the second element 102′ to pivot within a certain degree with respect to each other around three axes in space (the x-axis, the y-axis and the z-axis), and allow the first element 101′ and the second element 102′ to translate by a certain distance with respect to each other in the y-axis direction. However, the translation of the first element 101′ and the second element 102′ with respect to each other in the x-axis and z-axis directions are constrained.

The second connection unit 200′ is located on the right side of the front end portion of the lower panel 32 at a position which is substantially symmetric to the first connection unit 100′ with respect to the longitudinal center line of the lower panel 32. As an example, the second connection unit 200′ includes: a first element 201′ fixed on the vertical surface of the front casing 39 along the x-axis, a second element 202′ fixed on the lower panel 32 along the z-axis, and a third element 203′ that couples the first element 201′ and the second element 202′ together. The first element 201′ is a substantially cylindrical column which includes a column body and a head with a diameter smaller than that of the column body. The second element 202′ is an elongated panel with a through hole 2021′ at the upper end.

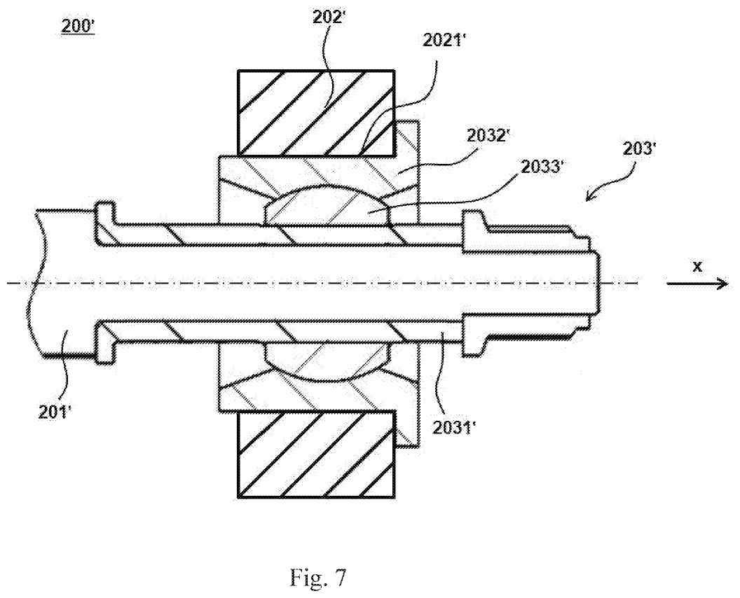

Specifically, as shown in FIG. 7, the third element 203′ includes at least a sliding bushing 2031′ mounted on the head of the first element 201′, a ball joint assembly fitted on the sliding bushing 2031′, and a stopper. The ball joint assembly includes a ball socket 2032′ and a ball head 2033′ that are arranged in the through hole 2021′ of the second element 202′ and are freely pivotable with respect to each other. The sliding bushing 2031′ passes through an inner hole of the ball head 2033′ and allows the ball head 2033′ to slide on an outer surface of the sliding bushing 2031′.

The second connection unit 200′ is configured to allow the first element 201′ and the second element 202′ to pivot within a certain degree with respect to each other around three axes in space (the x-axis, the y-axis, and the z-axis), and allow the first element 201′ and the second element 202′ to translate by a certain distance with respect to each other in the x-axis direction. However, the translation of the first element 201′ and the second element 202′ with respect to each other in the y-axis and z-axis directions are constrained.

The third connection unit 300′ is located close to the rear end of the lower panel 32 and includes: a first element 301′ fixed on the upper panel 31 along the z-axis, a second element 302′ fixed on the lower panel 32 along the z-axis, and a third element 303′ that couples the first element 301′ and the second element 302′ together along the x-axis. As an example, the first element 301′ is a lug with a through hole 3011′ at the lower end, the second element 302′ is a lug with a through hole 3021′ at the upper end, and a center line of the through hole of the first element 301′ is aligned with a center line of the through hole of the second element 302′. The third element 303′ passes through the above two through holes and couples the first element 301 and the second element 302 together.

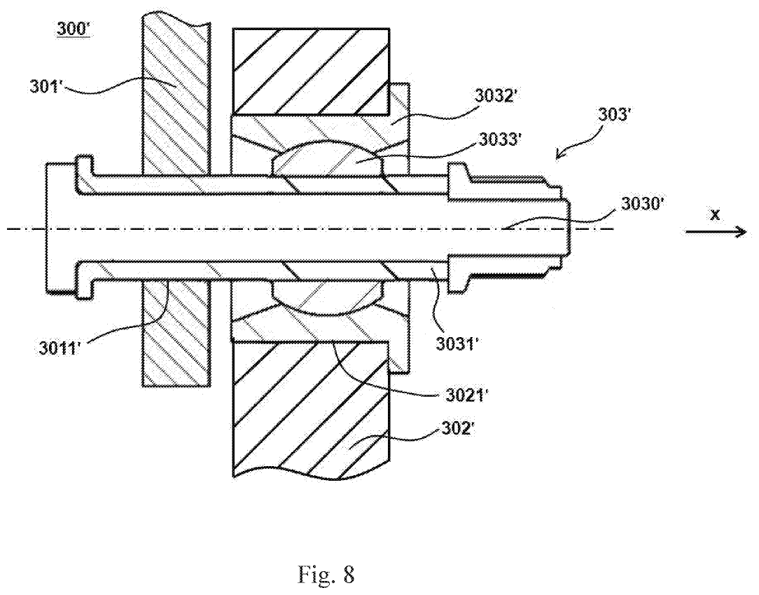

As specifically shown in FIG. 8, the third element 303′ includes a pin shaft 3030′, a sliding bushing 3031′ arranged on the pin shaft 3030′, a ball joint assembly and a stopper. The pin shaft 3030′ may be in the form of a pin, a bolt or a stud. The ball joint assembly includes a ball socket 3032′ and a ball head 3033′ that are arranged in the through hole 3021′ of the second element 302′ and are freely pivotable with respect to each other. The sliding bushing 3031′ passes through the through hole of the first element 301′ and an inner hole of the ball head 3033′ and allows the ball head 3033′ and the first element 301′ to slide on an outer surface of the sliding bushing 3031′.

The third connection unit 300′ is configured to allow the first element 301′ and the second element 302′ to pivot within a certain degree with respect to each other around three axes in space (the x-axis, the y-axis, and the z-axis), and allow the first element 301′ and the second element 302′ to translate by a certain distance with respect to each other in the x-axis direction. However, the translation of the first element 301′ and the second element 302′ with respect to each other in the y-axis and z-axis directions are constrained.

It should be understood by those skilled in the art that the connection unit according to the second embodiment may only constitute minimum constraints on a rigid body displacement of the panel member in the mechanical principle, i.e., the so-called statically determinate constraint, thereby providing as much free expansion space as possible for the lower panel while achieving the reliable connection of the lower panel. Based on this concept, it is preferable that, only three connection units are provided to collectively provide constraints, and the three connection units are not located on a same straight line. And preferably, the first element and the second element of each connection unit are untranslatable with respect to each other in a vertical direction. A preferred condition is that: the first element and the second element of one of the three connection units are untranslatable with respect to each other in the longitudinal and transverse directions, the first element and the second element of one of the remaining two of the connection units are translatable with respect to each other in the transverse direction or the longitudinal direction, and the first element and the second element of the other of the remaining two of the connection units are translatable with respect to each other in both the transverse direction and the longitudinal direction.

In addition to the preferred conditions described above, the three connection units may also constitute other equivalent translational constraint combinations in the mechanical principle. For example, the first element and the second element of each of only two connection units are translatable with respect to each other only in the longitudinal direction, and the first element and the second element of the remaining one connection unit are translatable with respect to each other only in the transverse direction. Alternatively, the first element and the second element of each of only two connection units are translatable with respect to each other only in the transverse direction, and the first element and the second element of the remaining one connection unit are translatable with respect to each other only in the longitudinal direction.

Further, it is conceivable to provide a fail-safe mechanism to ensure reliable operation of the three connection units. Alternatively, a fourth connection unit (a standby connection unit) may be provided which has a clearance for allowing a certain degree of rotation or sway of the panel member and does not participate in the constraint under normal conditions. In a case that any one of the above three connection units fails and the rotation or sway of the panel member exceeds the degree allowed by the reserved clearance, the fourth connection unit may provide supplementary constraints. With the fail-safe mechanism or the fourth connection unit, when any one of the three connection units fails, the uncontrolled large shaking or sway which is caused by the fact that the panel member and the fixing part cannot meet most basic constraints, may be avoided, thereby enhancing the reliability of the connection described in the present disclosure.

It should be appreciated by those skilled in the art from the above two embodiments that positions of connection units may be optional and are not limited to the above embodiments. Preferably, the connection units are arranged in the vicinity of a center of gravity of the lower panel 32 such that the connection units are evenly stressed. In addition, the first element of each connection unit is not limited to be disposed on the upper panel 31 or on the vertical surface of the front casing 39, and the first element may also be disposed on the lower edge of a rib, a middle wing panel (if provided), or any other possible components of the primary structure as needed. Practically, the positions of the connection units may be optimized based on the temperature distribution under the operation condition of the panel member, to avoid the high temperature region as much as possible, so as to prevent the operation temperatures of the connection units from being too high due to heat conduction, thereby improving the operation reliability and the service life of the connection units.

It should further be appreciated by those skilled in the art that configurations of the connection units are not limited to specific configurations shown herein, and may be implemented in any possible articulation and sliding manners as long as the elimination conditions on the rigid body freedom degree in the mechanical principle can be met.

The connection structures according to the embodiments of the present disclosure have significant advantages as compared with the related technology.

In an aspect, the need for fasteners is greatly reduced, and the cost and weight caused by the fasteners are reduced.

In another aspect, the assembly process is greatly simplified due to the significant reduction in the number of connectors or fasteners that need to be installed, thereby saving assembly/disassembly time and cost.

In another aspect, since the length of no fastener is required to be matched, the thickness of the lower panel may be reduced, and the requirement for the thickness tolerance may be reduced, thereby reducing the defective rate of products, saving the manufacturing cost, and reducing the weight of the lower panel.

In addition, it should further be noted that in the embodiments of the present disclosure, the lower panel 32 no longer needs to be directly rigidly connected to any component in the primary structure, and thus the lower panel 32 may not be in direct contact with the primary structure, and a clearance may exists between the lower panel 32 and the primary structure, which is very favorable in some aspects. For example, the ribs 37, 38, the side beams 35, 36, and the like may have a relatively simple shape and reduced size, and the high temperature and deformation of the lower panel 32 may be prevented from being transferred to other parts. Further, the lower panel 32 is provided with certain deformation space and is no longer fully constrained by the fasteners and other adjacent components, and the influence of the acoustic vibration fatigue on structures such as the fairing and the wing due to the structure resonance may be reduced, thereby prolonging the service life of the fairing and even the entire aircraft.

Although different configurations have been adopted for different connection units in the above embodiment for the convenience of illustrating possible configurations of the connection units, those skilled in the art can appreciate that in practice, the connection units may also have the same configuration. In this case, the components having the same configuration are suitable for mass production, which saves the cost.

In addition, although not shown, it is conceivable that the lateral panels 34 may also be connected by the connection unit as described herein, which also brings many benefits, for example, further reduces the need for the fasteners, simplifies the installation procedure of the aft pylon fairing, and simplifies the shapes of the lateral panels, the ribs and the side beams and reduces the sizes thereof.

Unlike fasteners such as rivets, the connection unit in the present disclosure only needs to bear an aerodynamic load and an inertial load, and the loads are much smaller than the thermal load, so that the probability of damage is greatly reduced, thereby reducing the number of maintenance and prolonging the service life.

Those skilled in the art may appreciate that under actual operation conditions, due to the uneven temperature distribution and the double curvature arc surface characteristic of the panel member, the panel member may be further arched or twisted under the thermal expansion effect, and the deformation of panel member even exceeds the assembly clearance reserved between the panel member and the fixing part. In this case, the panel member may be in contact with the fixing part. However, it can be seen from the computational analysis performed by the inventors, the contact load generated in this case is not increased by an order of magnitude with respect to the constraint load before the contact, that is, the constraint on the free expansion of the lower panel is not significantly increased. Further, it can be appreciated that the contact load and the constraint load after deformation may be optimized by appropriately setting the initial assembly clearance and the positions of the connection units, to ensure that the statically determinate constraint state is reached as close as possible.

According to the embodiments of the present disclosure, since the remaining fasteners in the aft pylon fairing do not need to bear a large load, a suitable type of fastener having a smaller size can be used, thereby further reducing the weight and reducing the manufacturing cost.

Although implementations of a non-rigid connection applied in an aircraft, particularly a non-rigid statically determinate connection are provided by taking an aft pylon fairing as an example in the present disclosure, those skilled in the art can appreciate that embodiments of the present disclosure are not limited to be applied to the aft pylon fairing, and may be applied to any possible structure (especially, the lower panel may correspond to an aircraft outer member that is easily deformed due to heat and/or used for maintaining the aerodynamic performance) in an aircraft as needed.

While the present disclosure has been described with reference to the exemplary embodiments, it should be understood that the present disclosure is not limited to the specific embodiments/examples described and illustrated in detail herein. Those skilled in the art can make various modifications to the exemplary embodiments without departing from the scope defined by the claims.

1. A structure for an aircraft, the structure comprising:
a fixed part;
a panel member which is an outer member of the structure; and
a plurality of connection units, each of which connects the panel member to the fixed part in an articulated manner, wherein
the plurality of connection units collectively forms a reliable connection between the panel member and the fixed part so as to make the structure be an iso-statically connected body.

2. The structure for an aircraft according to claim 1, wherein each of the plurality of connection units comprises:
a first element which is fixed to or integrally formed on the fixed part;
a second element which is fixed to or integrally formed on the panel member at a position corresponding to the first element; and
a third element which couples the first element and the second element together, wherein the third element is configured to allow the first element and the second element to pivot with respect to each other or allow the first element and the second element to pivot and translate with respect to each other.

3. The structure for an aircraft according to claim 2, wherein the plurality of connection units comprise at least a first connection unit and a second connection unit, and the first connection unit and the second connection units are arranged to allow the panel member to pivot with respect to the fixing part around a first axis and a second axis in different directions, respectively, so that the first connection unit and the second connection unit collectively form reliable connection between the panel member and the fixing part.

4. The structure for an aircraft according to claim 3, wherein
both the first axis and the second axis extend along a plane in which the panel member is located, and
the first element and the second element of the first connection unit are connected via the third element of the first connection unit to be translatable by a distance with respect to each other along the first axis, and/or the first element and the second element of the second connection unit are connected via the third element of the second connection unit to be translatable by a distance with respect to each other along the second axis.

5. The structure for an aircraft according to claim 2, wherein the plurality of connection units comprise a first connection unit, a second connection unit and a third connection unit, the first connection unit, the second connection unit and the third connection unit collectively form statically determinate connection between the panel member and the fixing part.

6. The structure for an aircraft according to claim 5, wherein the first connection unit, the second connection unit, and the third connection unit are arranged to allow the panel member to pivot with respect to the fixing part around three axes in space, respectively, and the first connection unit, the second connection unit and the third connection unit are arranged in a non-collinear manner.

7. The structure for an aircraft according to claim 6, wherein
the first element and the second element of one of the first connection unit, the second connection unit, and the third connection unit are connected via the corresponding third element to be untranslatable with respect to each other, the first element and the second element of one of the remaining two of the connection units are connected via the corresponding third element to be translatable with respect to each other along a first axis on a plane in which the panel member is located, and the first element and the second element of the other of the remaining two of the connection units are connected via the corresponding third element to be translatable with respect to each other along both the first axis and a second axis different from the first axis on the plane in which the panel member is located; or
the first element and the second element of one of the first connection unit, the second connection unit and the third connection unit are connected via the corresponding third element to be translatable with respect to each other along a first axis on a plane in which the panel member is located, and the first element and the second element of each of the remaining two of the connection units are connected via the corresponding third element to be translatable with respect to each other along a second axis different from the first axis on the plane in which the panel member is located.

8. The structure for an aircraft according to claim 5, wherein
the plurality of connection units further comprise at least one standby connection unit, the standby connection unit is configured to provide complementary constraints in a case that one or more of the first connection unit, the second connection unit and the third connection unit fail; and/or
one or more of the first connection unit, the second connection unit and the third connection unit are provided with a fail-safe mechanism.

9. The structure for an aircraft according to claim 2, wherein the fixed part comprises:
at least one vertical wall that extends substantially perpendicular to the panel member, wherein the first elements of one or more of the connection units are fixed to or integrally formed on the at least one vertical wall; and/or
a base plate that extends substantially parallel to the panel member, wherein the first elements of one or more of the connection units are fixed to or integrally formed on the base plate.

10. The structure for an aircraft according to claim 9, wherein the fixed part comprises:
a front casing that is located at a front end in a longitudinal direction of the structure, wherein the front casing comprises a vertical surface adjacent to a front end of the panel member, and the vertical surface serves as the vertical wall; and/or
a plurality of vertical ribs that extend substantially perpendicular to the base plate in a transverse direction of the structure and are arranged side by side in the longitudinal direction of the structure, wherein each of the vertical ribs serves as the vertical wall.

11. The structure for an aircraft according to claim 2, wherein the third element comprises at least one of a pin, bolt or stud, a rolling bearing and a joint bearing that allows the first element and the second element to pivot with respect to each other.

12. The structure for an aircraft according to claim 11, wherein the third element further comprises a sliding bushing that facilitates the relative translation between the first element and the second element.

13. The structure for an aircraft according to claim 1, wherein the plurality of connection units have the same or similar configuration.

14. The structure for an aircraft according to claim 1, wherein
there is no rigid connection between the panel member and other parts of the structure than the panel member, or
there is no rigid connection between the panel member and other parts of the structure than the panel member, and there is no direct contact between the panel member and other parts of the structure than the panel member under the circumstance that the panel member is not expanded and deformed.

15. The structure for an aircraft according to claim 1, the structure further comprising:
a pair of lateral panels that are respectively connected on two sides of the structure in a transverse direction and extend in a longitudinal direction of the structure, wherein the panel member, the fixed part and the pair of lateral panels collectively form a box configuration.

16. The structure for an aircraft according to claim 15, the structure further comprising:
a plurality of secondary connection units, wherein each of the plurality of secondary connection units connects a corresponding one of the pair of lateral panels to the fixed part in an articulated manner, so as to form reliable connection between the lateral panel and the fixed part and make the structure have an invariant geometry.

17. The structure for an aircraft according to claim 1, wherein the structure is an aft pylon fairing, and the panel member is an outer panel of the aft pylon fairing for maintaining aerodynamic performance and/or for heat protection.

18. A suspension system for an engine, wherein the suspension system is arranged between an aircraft wing and the engine and is located below or above the aircraft wing, and the suspension system comprises an aft pylon fairing that is implemented as the structure according to claim 1.

19. An engine assembly comprising an engine and the suspension system according to claim 18.

20. An aircraft (AC) comprising at least one engine assembly according to claim 19.
